(19) United States
(12) Patent Application Publication
(10) Pub. No.: US 2022/0037053 A1
(43) Pub. Date: Feb. 3, 2022

(54) CORD REEL AND FLAT POWER CORD

(71) Applicant: Lippert Components, Inc., Elkhart, IN (US)

(72) Inventors: Robert L. TIEDGE, Granger, IN (US); Mark KINDER, Clarks Hill, IN (US)

(21) Appl. No.: 17/387,729

(22) Filed: Jul. 28, 2021

Related U.S. Application Data
(60) Provisional application No. 63/057,499, filed on Jul. 28, 2020.

(51) Int. Cl. H01B 7/08; H01B 9/00

(52) U.S. Cl. CPC H01B 7/0807; H01B 9/006; H01B 7/0823

(57) ABSTRACT

A multi-conductor flat cable having a width and a thickness includes a plurality of individual conductors arranged side-by-side. The conductors include first and second power conductors, a neutral conductor, and a ground conductor.

### CROSS-REFERENCES TO RELATED APPLICATIONS

This application claims the benefit of U.S. Provisional Patent Application Ser. No. 63/057,499, filed Jul. 28, 2020, the entire content of which is herein incorporated by reference.

### STATEMENT REGARDING FEDERALLY SPONSORED RESEARCH OR DEVELOPMENT

(NOT APPLICABLE)

### BACKGROUND

Electrical cord reels are known in the art. An electrical cord reel typically includes a frame and a reel that may rotate with respect to the frame. An electrical cord may be electrically connected to the reel, wound onto the reel by rotating the reel in a first direction, and wound off of the reel by rotating the reel in a second direction. Such cord reels typically allow for wrapping of a cord onto a center section in a side-by-side arrangement, such that the cable reel may be substantially wider than the width or diameter of the cord wound thereon.

RV power extension cords that connect the vehicle to outside power are typically in the form of a shore power cord that is round and bulky. The size and weight of a shore power cord can complicate unreeling, reeling, and storage of the RV power cord.

Many such cord reels use an electrical slip ring and brush assembly to maintain electrical continuity between the rotating reel and the frame. Such slip ring assemblies are prone to malfunction, however, due to, for example, contamination of the slip ring/brush interface.

Efforts have been made to overcome the foregoing issue by replacing the slip ring assembly with a festoon cable that affects electrical continuity between the reel and the frame.

Additionally, electrical cords are known in the art. The RV and marine industry typically utilize the round and bulky shore power cords mentioned above for powering a vehicle or boat via connection to an outside power source. The most common RV connections are 30 amps and 50 amps. The RV industry does not currently utilize the potential difference of 240v and only utilizes 120v potential from each power wire to the neutral wire. Wire gauges of 8 AWG and 10 AWG are commonly used in 50 amp and 30 amp cords, respectively. Wires of 8 AWG or 10 AWG can be manufactured as one single strand of conducting material, which is not compatible with multiple bending and leaves the wires susceptible to breakage.

### SUMMARY

The present disclosure is directed to an electrical cable assembly including a festoon cable and a main power cable, a cable reel, and a housing, where the festoon cable is connected between rotating and fixed elements of the assembly. The disclosure is further directed to a main power cord that comprises a flat cord for providing electrical connection between a vehicle and a generator or an outside power source. The disclosure is even further directed to a mechanical cable reel without a housing that includes a main power cord and a crank.

In an exemplary embodiment a multi-conductor flat cable having a width and a thickness includes a plurality of individual conductors arranged side-by-side, with first and second power conductors, a neutral conductor, and a ground conductor. The first and second power conductors may include 8 AWG power conductors. The neutral conductor may include a 6 AWG neutral conductor. The ground conductor may include a 6 AWG ground conductor.

In some embodiments, the plurality of individual conductors are rated to carry a 50 ampere current.

In some embodiments, the neutral conductor and the ground conductor may be outermost conductors, and the first and second power conductors may be inner conductors.

In another exemplary embodiment, a multi-conductor flat cable in combination with a main cable includes the multi-conductor flat cable having a width and a thickness with a plurality of individual conductors arranged side-by-side, including first and second power conductors, a neutral conductor, and a ground conductor. The main cable includes a flat flexible cable including 8-gauge wires set in a linear or side-by-side formation. The main cable is electrically coupled to the multi-conductor flat cable at a first end and is secured to an electrical fitting at a second end.

The main cable may include a 50 AMP cable. At least one of the multi-conductor flat cable and the main cable may include a NEMA 14-50 P plug secured and sealed or otherwise molded to one end. The neutral conductor and the ground conductor may be arranged as outermost conductors, where the first and second power conductors may be arranged as inner conductors.

In yet another exemplary embodiment, a free-standing flat power cord having a width and a thickness includes a 30 or 50 amp cord with a plurality of conductors, where the conductors include multiple strands. The 30 amp cord may be provided with 10 AWG wires, and the 50 amp cord may be provided with 8 AWG wires. In some embodiments, the conductors include 125 strands.

In some embodiments, the flat power cord includes individually insulated wires disposed in a flat cord jacket. In this context, the flat power cord may include four conductors including first and second power conductors, a neutral conductor, and a ground conductor. With the 50 amp cord, a potential difference between the first and second power conductors may be 240v, and a potential difference between the first and second power conductors and the neutral conductor may be 120v. A potential difference between either of the first and second power conductors and the ground conductor may be 120v.

The power cord may be rated for 600v and may provide an output of 4 kW-h or higher. Electrical fittings may be secured to first and second ends configured to connect an RV power outlet to an outside power source.

### BRIEF DESCRIPTION OF THE DRAWINGS

These and other aspects and advantages will be described in detail with reference to the accompanying drawings, in which:

FIG. 1A is a perspective view of an illustrative cable assembly, cable reel, and housing according to the present disclosure;

FIG. 1B is a front elevation view of the cable reel and housing of FIG. 1A;

FIG. 1C is an end elevation view of the cable reel and housing of Fig. A;

FIG. 1D is a top elevation view of the cable reel and housing of FIG. 1A;

FIG. 1E is an exploded view of the cable assembly, cable reel, and housing of FIG. 1A;

FIG. 2A is an interior perspective view of a front panel of the housing of FIG. 1A;

FIG. 2B is a rear elevation view of the front panel of FIG. 2A;

FIG. 2C is a third side elevation view of the front panel of FIG. 2A;

FIG. 2D is a fourth side elevation view of the front panel of FIG. 2A;

FIG. 3A is an exterior perspective view of a rear panel of the housing of FIG. 1A;

FIG. 3B is an exterior elevation view of the rear panel of FIG. 3A;

FIG. 3C is an end view of the rear panel of FIG. 3A;

FIG. 4A is a perspective view of the a cable assembly of FIG. 1A;

FIG. 4B is a front elevation view of the cable assembly of FIG. 4A;

FIG. 4C is an end elevation view of the cable assembly of FIG. 4A;

FIG. 5A is a front perspective view of the cable reel of FIG. 1A;

FIG. 5B is a rear perspective view of the cable reel of FIG. 5A;

FIG. 5C is a front elevation view of the cable reel of FIG. 5A;

FIG. 5D is a rear elevation view of the cable reel of FIG. 5A;

FIG. 5E is an end elevation view of the cable reel of FIG. 5A;

FIG. 6A is a perspective view of an illustrative main cable hub of the cable reel of FIG. 1A;

FIG. 6B is a side elevation view of the main cable hub of FIG. 6A;

FIG. 6C is an end elevation view of the main cable hub of FIG. 6A;

FIG. 7A is a perspective view of a base of the cable reel of FIG. 1A;

FIG. 7B is an elevation view of the base of FIG. 7A;

FIG. 7C is an end elevation view of the base of FIG. 7A;

FIG. 7D is a cross-sectional view of the base of FIG. 7A;

FIG. 8 is a perspective view of a standard shore power cable next to a flat power cord;

FIG. 9 is a top perspective view of an alternative embodiment of a cable assembly;

FIG. 10 is a perspective view of an alternate cord assembly and reeling mechanism;

FIG. 11 is another perspective view of the cord assembly and reeling mechanism of FIG. 10;

FIG. 12 is an exemplary front perspective view of an installed cord reel and housing;

FIG. 13 is a side perspective view of the installed cord reel and housing of FIG. 12;

FIG. 14A is a perspective view of an alternative embodiment of a cord assembly and cord reel;

FIG. 14B is a top view of the cord assembly and cord reel of FIG. 14A;

FIG. 14C is a side view of the cord assembly and cord reel of FIG. 14A;

FIG. 14D is a bottom view of the cord assembly and cord reel of FIG. 14A;

FIG. 15 is a perspective view of the cord assembly and cord reel of FIG. 14A in a locked position;

FIG. 16 is a perspective view of the cord assembly and cord reel of FIG. 14A in a released position; and

FIG. 17 lists exemplary connectors for connecting an RV power outlet to an outside power source.

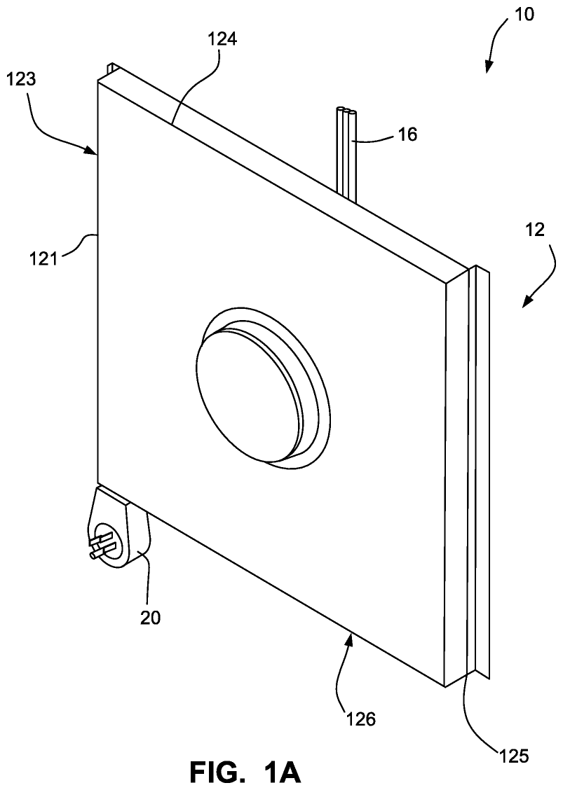

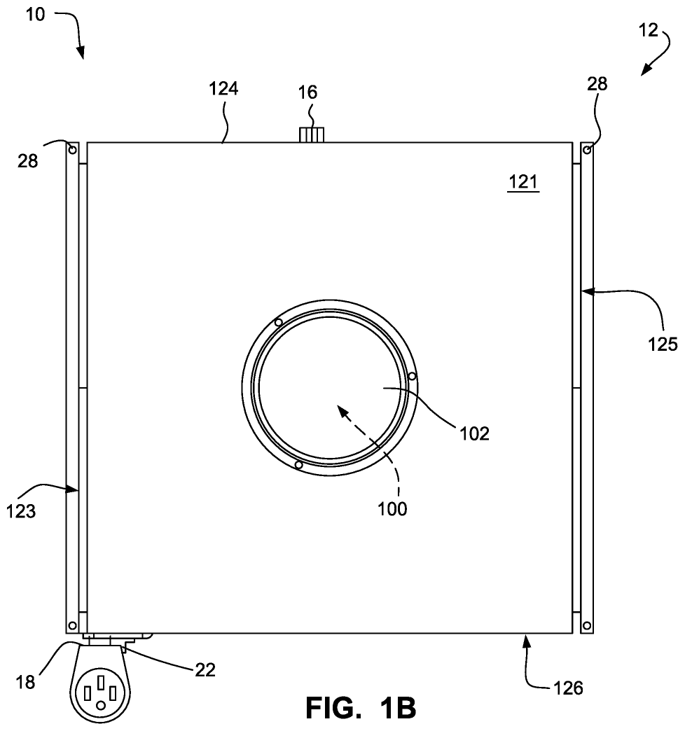

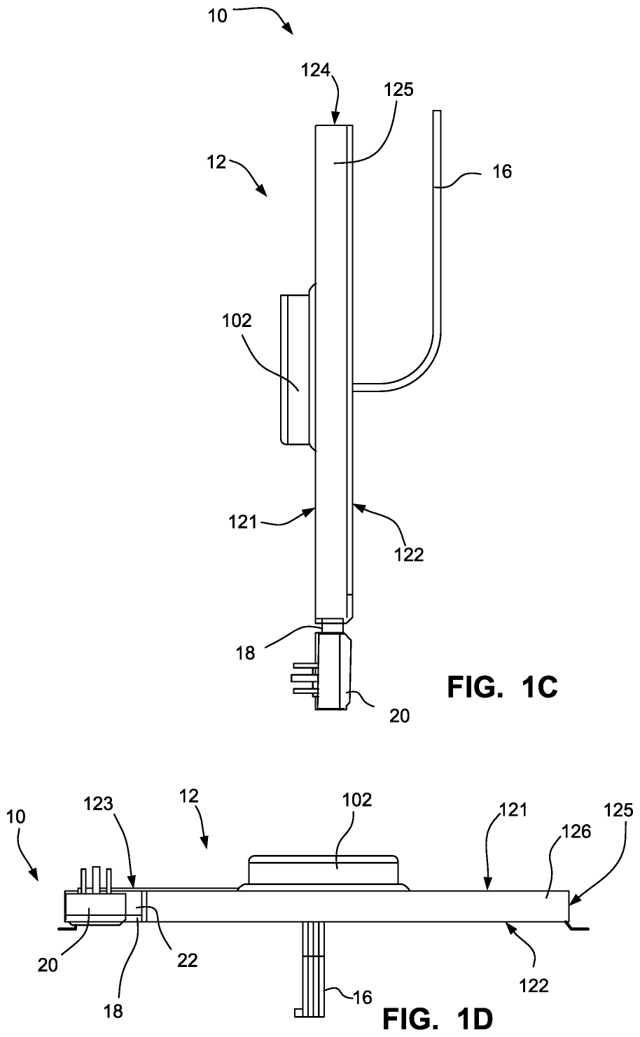

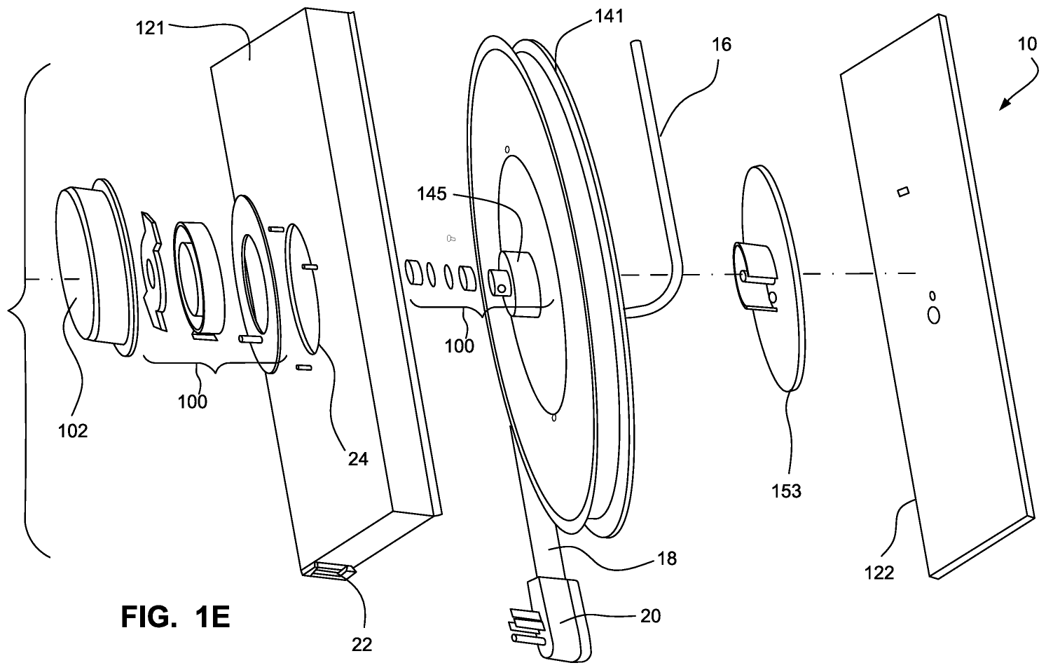

### DETAILED DESCRIPTION

The drawings show an illustrative electrical cable reel assembly 10 according to the present disclosure. For the purposes of the following disclosure, the term ‘cable’ is used to describe an electrical conductor that is generally fixed, while the term ‘cord’ is used to describe an electrical conductor that is free-standing, mobile, or removable. The cable reel assembly 10 includes a housing 12, and a cable reel 14 disposed within the housing. The cable reel 14 carries a cable assembly including festoon cable 16 and a main cable 18. A first end of the festoon cable 16 extends outwardly from the housing 12. The first end of the festoon cable 16 may be configured for connection to an electrical panel (not shown) or component of a recreational vehicle or other structure to which the cable reel 10 may be attached. The festoon cable 16 may be fixed or otherwise connected to the housing 12 at or near the point where the festoon cable exits the housing 12. A second end of the festoon cable 16 is fixed or otherwise connected to the cable reel 14. A first end of the main cable 18 is fixed or otherwise connected to the cable reel 14 and electrically connected to the festoon cable 16. Festoon cable 16 unwinds with the main cable 18 as cable reel 14 is rotated. In an exemplary embodiment, the number of rotations of the main cable 18 should equal the number of rotations required by the festoon cable 16 for proper unwinding of the system. An electrical fitting 20, for example, a plug or socket, may be electrically connected to the second end of the main cable 18. The main cable 18 may be selectively unwound from and wound onto the cable reel 14, and thereby may be selectively extended from and withdrawn into the housing 12.

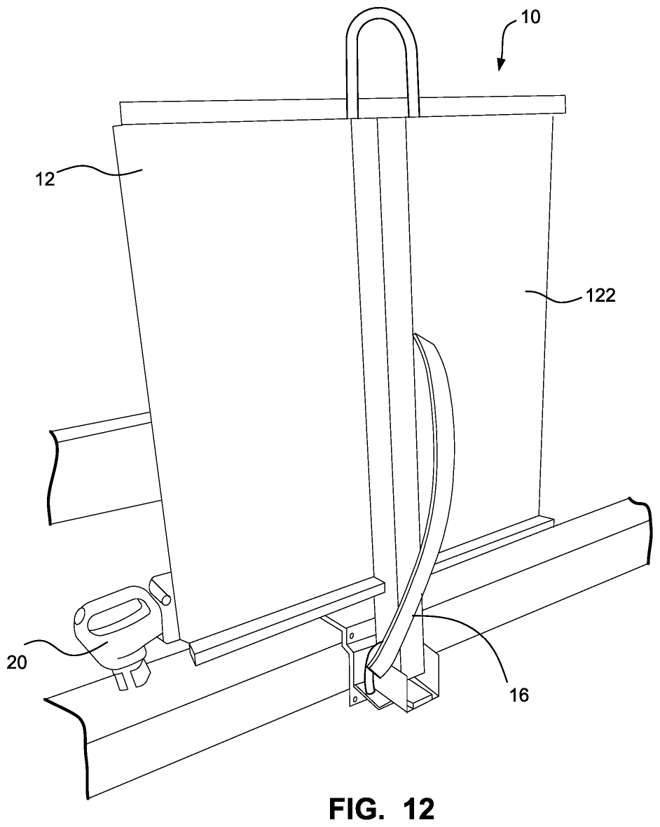

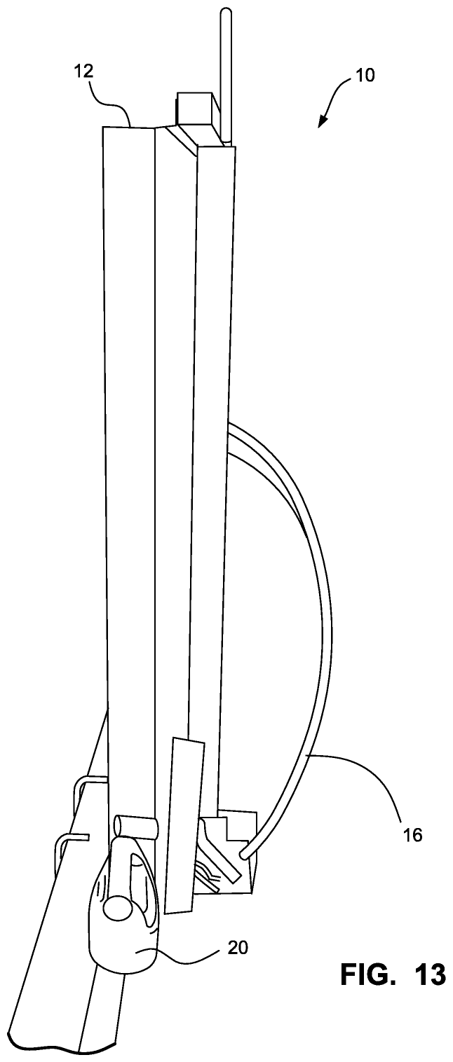

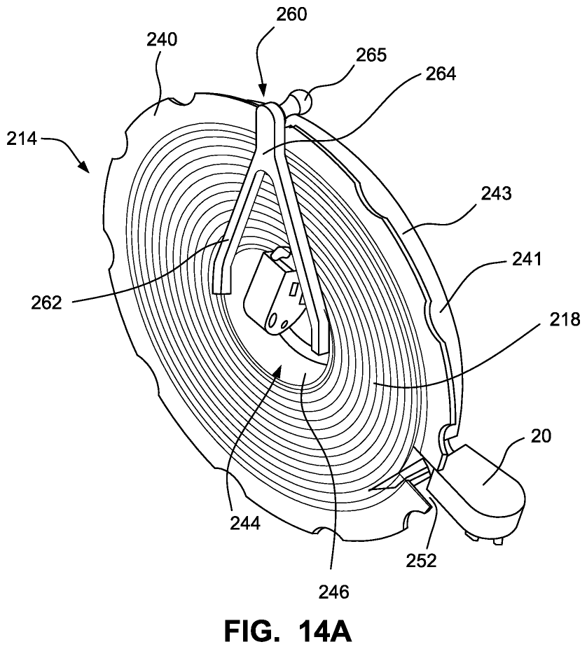

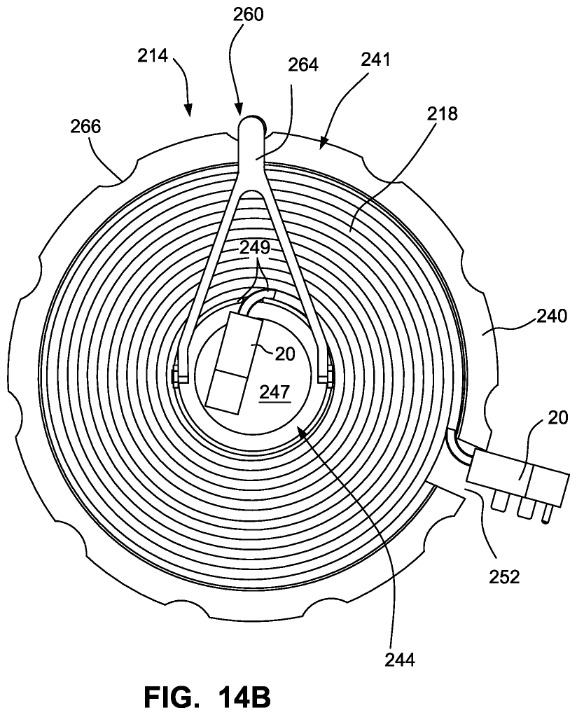

As shown, the housing 12 may be configured as a square box including a first (or front) panel or plate 121 and a second (or rear) panel or plate 122 spaced from and generally parallel to the front panel. The first panel 121 may be separated from the second panel 122 by a distance no greater than necessary to accommodate the cable reel 14 in a manner enabling the cable reel to be disposed within and freely rotate about an axis within the housing. The housing 12 as described below may be mounted in any suitable place about the vehicle, including but not limited to the underside of the vehicle, on a bumper or rear door of the vehicle or fifth-wheel, the side of the vehicle or fifth-wheel, or within a storage compartment of the vehicle. An example of the mounted housing and assembly is shown in FIGS. 12-13.

First through fourth side panels 123-126 extend from the front panel 121 to the rear panel 122. In other embodiments, the housing 12 may have a different shape, for example, round or other-than-square polygonal. Such other embodiments may have a number of side panels similar to side panels 123-126 that is appropriate for the shape of the housing 12. For example, a round housing may have one side panel and a hexagonal housing may have six side panels.

In the embodiment shown, the first, second, and third side panels 123, 124, 125 extend the entire length of the corresponding side edges of the front and rear panels 121, 122 of the housing 12 and are substantially imperforate. The fourth side panel 126 is configured to define (in cooperation with the first side panel 123 and the front and rear panels 121, 122) a first (or main cable) aperture 22. The first aperture 22 may be defined, for example, by an aperture in the fourth side panel 126 or by a gap between respective ends of the fourth side panel 126 and the first side panel 123. The first aperture 22 is dimensioned or otherwise configured to allow the main cable 18 to be extended and retracted therethrough, yet not allow the electrical fitting 20 to pass readily therethrough, upon normal extension and retraction of the main cable from and into the housing. In other embodiments, any side panel or combination of side panels may define the first aperture 22. A plug housing or receptacle (not shown) may be integrated with the cable reel housing 12 for storage and protection of the electrical fitting 20 during transit or while not in use.

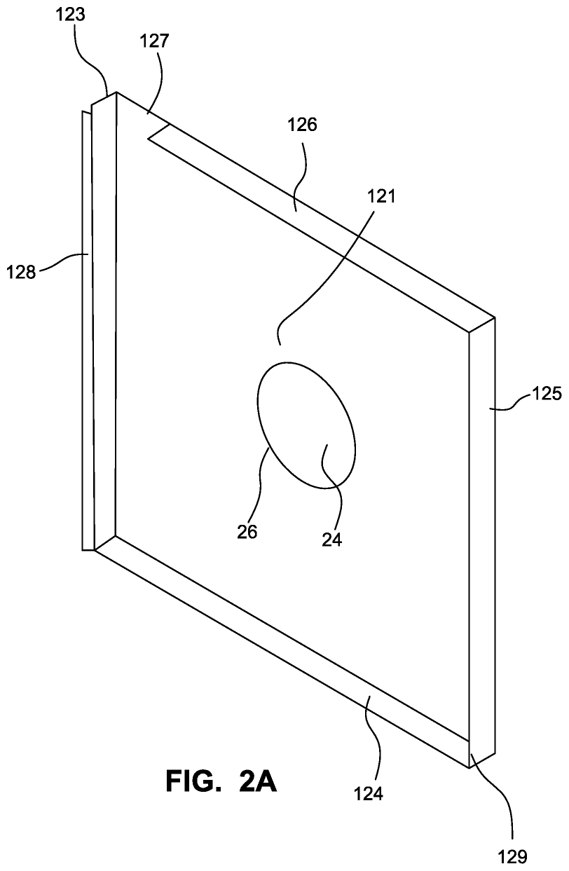

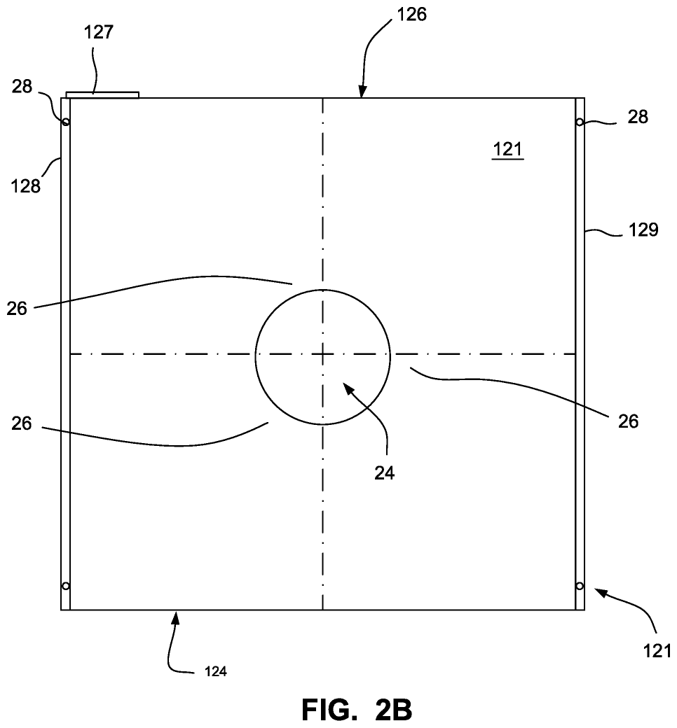

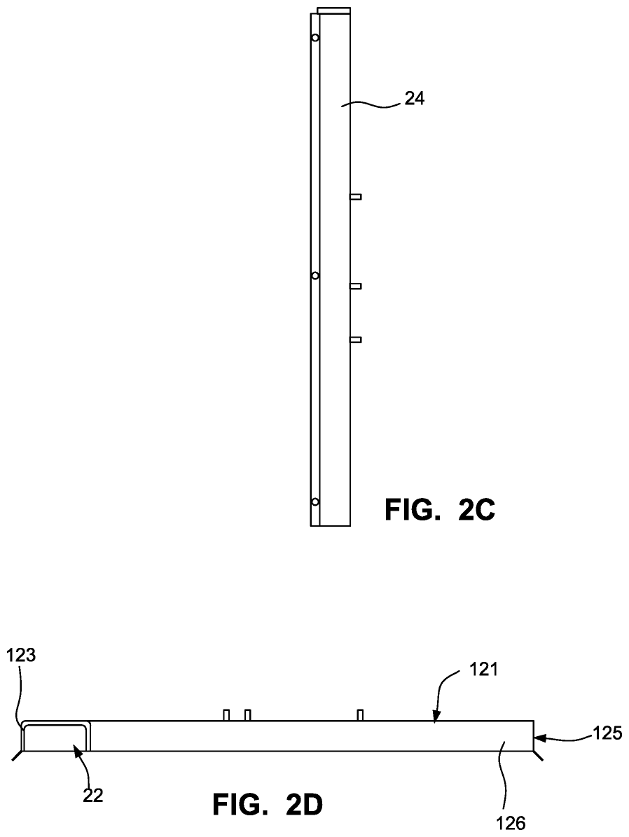

FIGS. 2A-2D are various views of the front panel 121 and the four side panels 123-126 of the housing 12. As shown, the front panel 121 is generally square. The front panel 121 defines a first, relatively large, front panel aperture 24 therethrough and three, relatively small, second front panel apertures 26 therethrough. Other embodiments may include more or fewer front panel apertures. The first front panel aperture 24 is configured to receive a winding mechanism or portion of a winding mechanism therethrough, the winding mechanism configured to rotate the cable reel 14. The second front panel apertures 26 are configured to receive mechanical fasteners for connecting the winding mechanism or a cover therefor to the front panel 121, as will be discussed further below.

Each of the first, second, and third side panels 123, 124, 125 is substantially rectangular and imperforate, and each extends perpendicularly in the same direction from a corresponding edge of the front panel 121. The first and second side panels 123, 124 are joined at respective corners thereof, the second and third side panels 124, 125 are joined at respective corners thereof, and the third and fourth side panels 125, 126 are joined at respective corners thereof. The fourth side panel 126 also is substantially rectangular, and it extends perpendicularly from a corresponding edge of the front panel 121 in the same direction that the first through third side panels 123-125 extend from the front panel 121. Unlike the first through third side panels 123-125, the fourth side panel 126 defines a gap corresponding to the opening 22. A rib 127 extends perpendicularly outwardly from the fourth side panel 126 about the gap. The rib 127 may serve as a stiffener and/or to inhibit abrasion of the main cable 18 as the main cable is extended from and retracted into the housing 12.

The fourth and first side panels 126, 123 are joined at respective corners thereof. The foregoing respective corner of the fourth side panel 126 could coincide with the rib 127. In an embodiment, the fourth side panel 126 could extend only partially from the third side panel 125 to the first side panel 123, thereby defining a gap corresponding to the opening 22. In another embodiment, both the first side panel 123 and the fourth side panel 126 could terminate short of the corner where they are “joined” in the illustrated embodiment, thereby defining a gap corresponding to the opening 22.

As shown in FIGS. 2A-2D, a first front panel flange 128 may extend perpendicularly outwardly from the first side panel 123, and a second front panel flange 129 may extend perpendicularly outwardly from the third side panel 125. Either or both of the first and second front panel flanges 128, 129 may define one or more front panel flange apertures 28 configured to receive mechanical fasteners, as will be discussed further below.

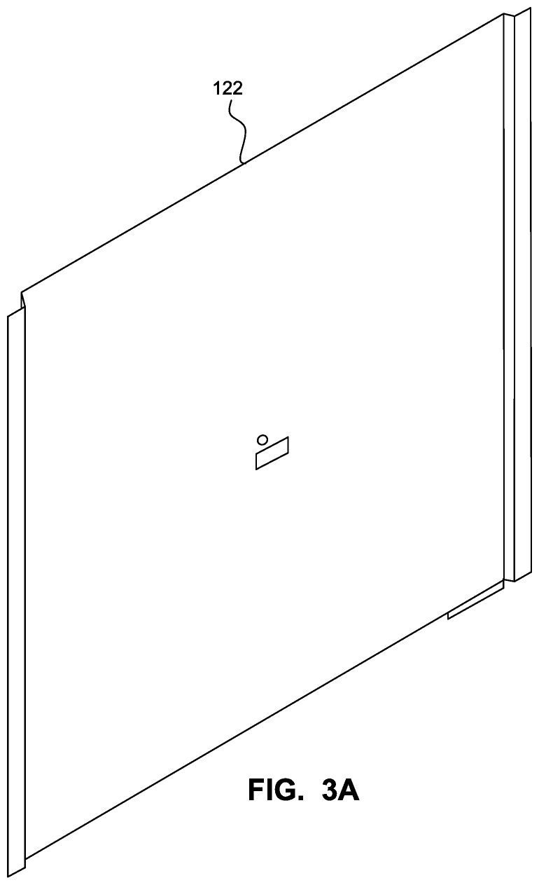

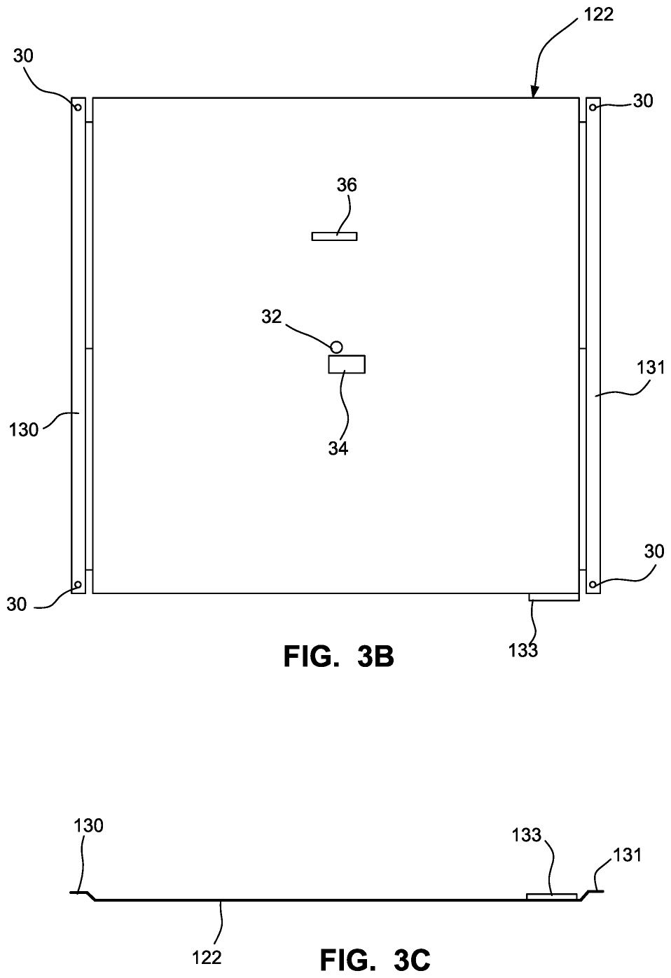

FIGS. 3A-3C are various views of the rear panel 122 of the housing 12. The rear panel 122 is generally square and planar, having a shape complementary to the front panel 121. A first rear panel flange 130 extends diagonally and outwardly from a first edge of the rear panel 122, and a second rear panel flange 131 extends diagonally and outwardly from an opposite third edge of the rear panel 122. Either or both of the first and second rear panel flanges 130, 131 may define one or more rear panel flange apertures 30 configured to receive mechanical fasteners, as will be discussed further below. The rear panel flange apertures 30 may be configured to coaxially overlie the front panel flange apertures 28 when the rear panel 122 is assembled to the front panel 121, as will be discussed further below.

The rear panel 122 defines a first, circular rear panel aperture 32 proximate the center thereof. The first rear panel aperture 32 is configured to receive a cable carrier axle supporting the cable reel 14 in rotating engagement, as will be discussed further below. The rear panel 122 also defines a second, rectangular rear panel aperture 34 proximate the first rear panel aperture 32. The second rear panel aperture 34 is configured to receive the festoon cable 16 therethrough. The rear panel 122 further defines a slotted aperture 36 intermediate (for example, about midway between) the first rear panel aperture 32 and a second edge of the rear panel 122 extending between the first and third edges of the rear panel. The slotted aperture 36 is configured to receive an anti-rotation tab of a festoon cable support, as will be discussed further below. A guide bar 133 may be attached to a portion of the fourth edge of the rear panel 122, for example, by welding or bonding. When the rear panel 122 is assembled to the front panel 121, the guide bar 133 cooperates with corresponding elements of the front panel to define the opening 22 in the housing 12 through which the main cable 18 may be extended and retracted. The guide bar 133 may be configured as an elongated cylinder having a relatively smooth circumferential periphery to inhibit abrasion of the main cable 18 as the main cable is extended from and retracted into the housing 12.

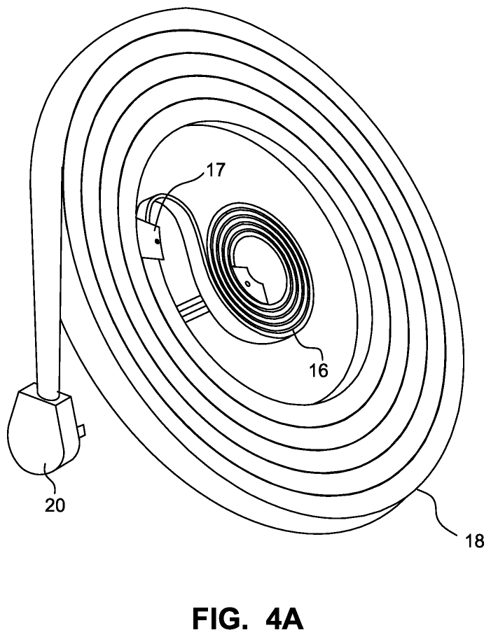

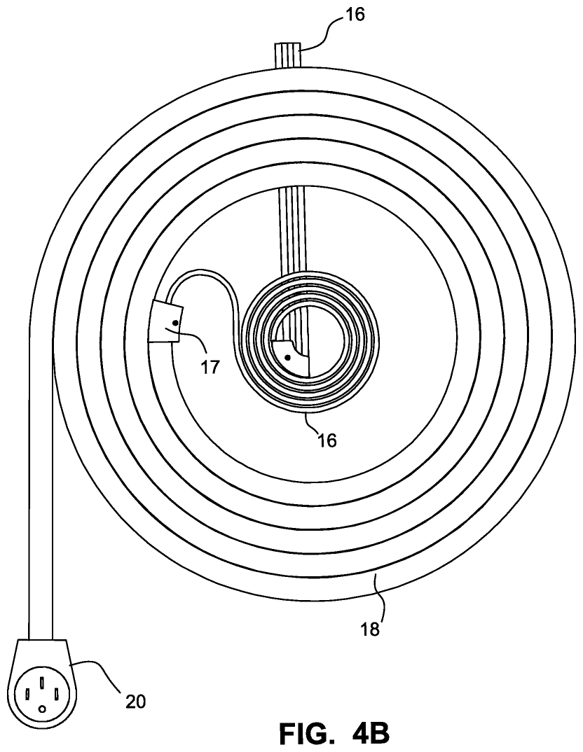

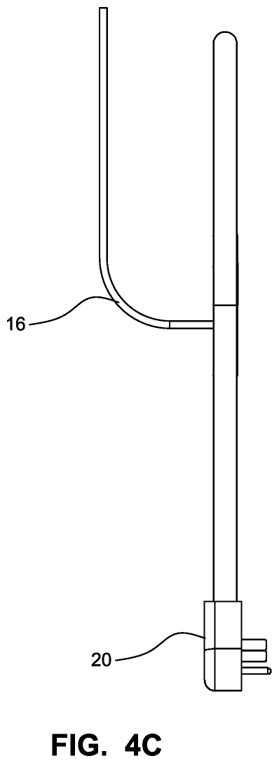

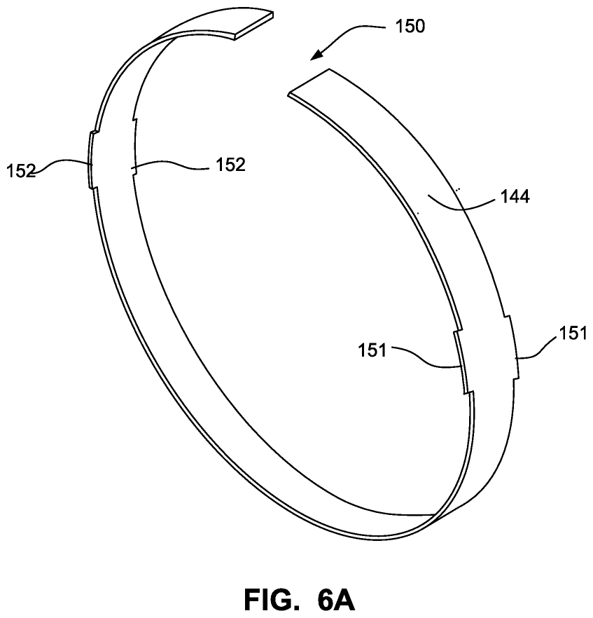

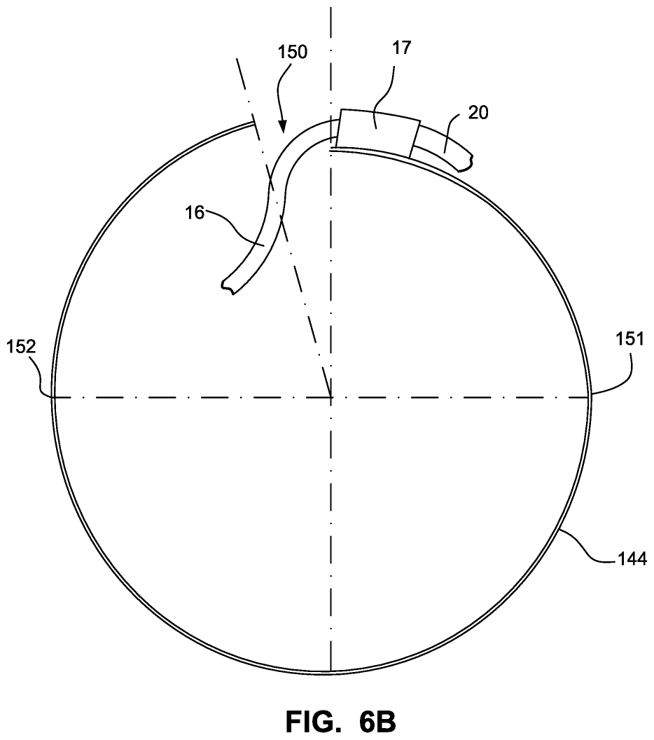

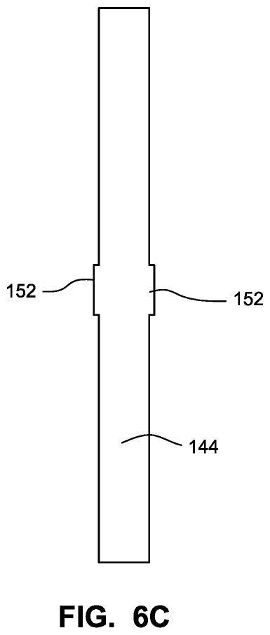

FIGS. 4A-4C show an illustrative cable assembly including the festoon cable 16, the main cable 18, and the electrical fitting 20 attached to the second end of the main cable. FIG. 6B also shows a cable anchor in the form of an electrical junction block 17 electrically connected between the festoon cable 16 and the main cable 18. The electrical junction block 17 may function as a strain relief.

The festoon cable 16 is shown as a multi-conductor flat cable having a width and a thickness, with the individual conductors thereof arranged side-by-side. In other embodiments, the festoon cable 16 could take other forms, for example a round form. The main cable 18 is shown as a multi-conductor round cable having a diameter. In other embodiments, the main cable 18 could take other forms, as will be described below.

In an embodiment, each of the festoon cable 16 and the main cable may include four conductors, namely, first and second power conductors, for example, #8 AWG power conductors; a neutral conductor, for example, a #6 AWG neutral conductor; and a ground conductor, for example, a #6 AWG ground conductor. In an embodiment, the main cable 18 conductors may be as described above, and each of the festoon cable 16 conductors may be a #8 AWG conductor. In other embodiments, each of the festoon cable 16 and the power cable 18 may have more or fewer (any desired number) conductors of any desired AWG. In an embodiment, the conductors of each of the festoon cable 16 and the main cable 18 may be rated to carry a 50 ampere current.

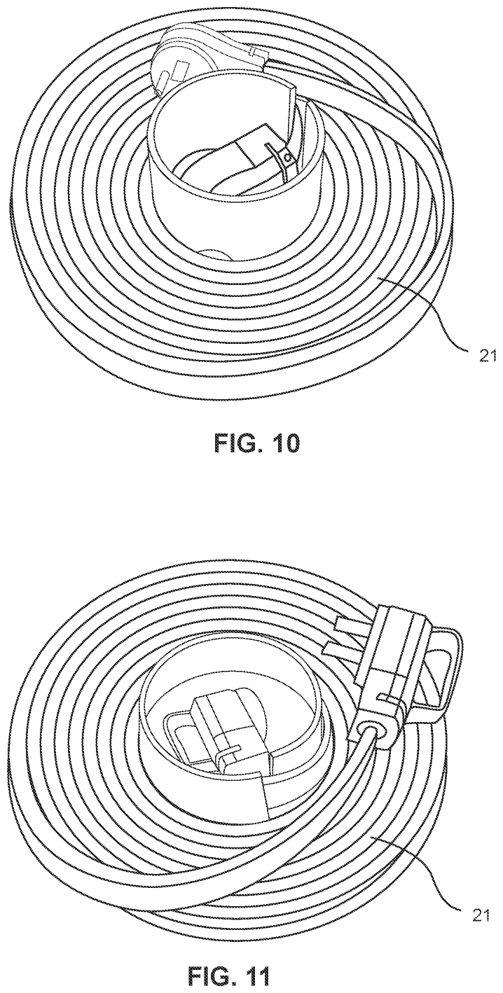

In another embodiment shown in FIG. 9, the main cable 18 may be a second festoon-like flat cable 19. For example, the second flat cable may be a 50 AMP flat, flexible cable with similar specifications described above. The flat cable may have 8-gauge wires set in a linear or side-by-side formation, which allows for quicker dissipation of heat during use. In this embodiment, the main flat cable 19 is electrically coupled to festoon cable 16 at a first end and is secured to an electrical fitting 20 at a second end.

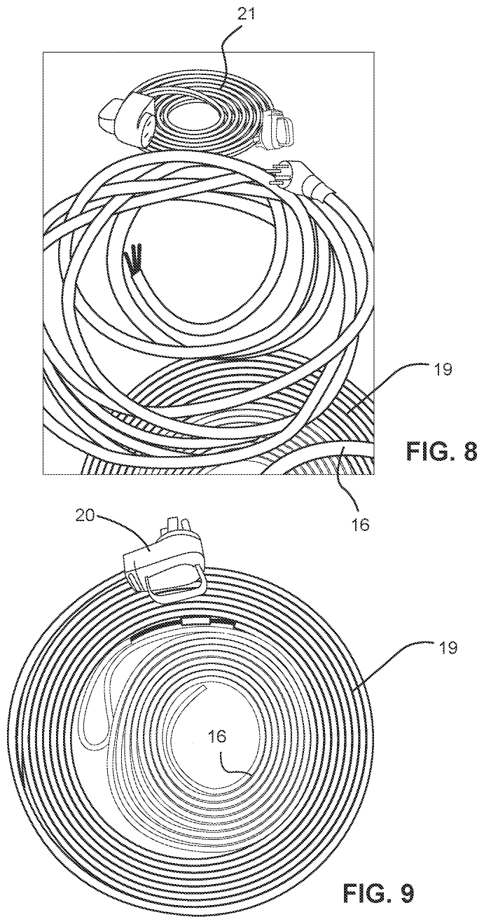

In other embodiments, a free-standing flat power cord could be either a 30 or 50 amp cord. The 30 amp cord generally utilizes 10 AWG wires and the 50 amp cord generally utilizes 8 AWG wires. The 10 AWG and 8 AWG conductors are manufactured with multiple strands, and preferably 125 strands. This construction with a higher count of smaller strands creates more flexibility and durability of the cord that is similar to that of a festoon cable. This flexibility and durability is desired in an RV or marine power cord as it will be folded and put under more stress than a household or lower-capacity cord or cable. The flat power cord may be constructed of individually insulated wires disposed in a flat cord jacket. The flat, flexible cord may also have a reduced weight compared to the standard shore power cord, shown in FIG. 8, which allows for easier and more compact storage.

As mentioned previously, the free-standing flat power cord may also include four conductors, namely, first and second power conductors, a neutral conductor, and a ground conductor. In other embodiments, the flat power cord may have more or fewer (any desired number) conductors of any desired AWG. With regard to the 50 amp cords, the potential difference between the two power conductors is 240v and the potential difference between each power conductor and the neutral conductor is 120v. Additionally, the potential difference between either of the two power conductors and the ground wire is 120v. The flat power cord of the present disclosure is rated for 600v with application never exceeding 240v. The flat power cord or cable generally provides an output of 4 kW h or higher.

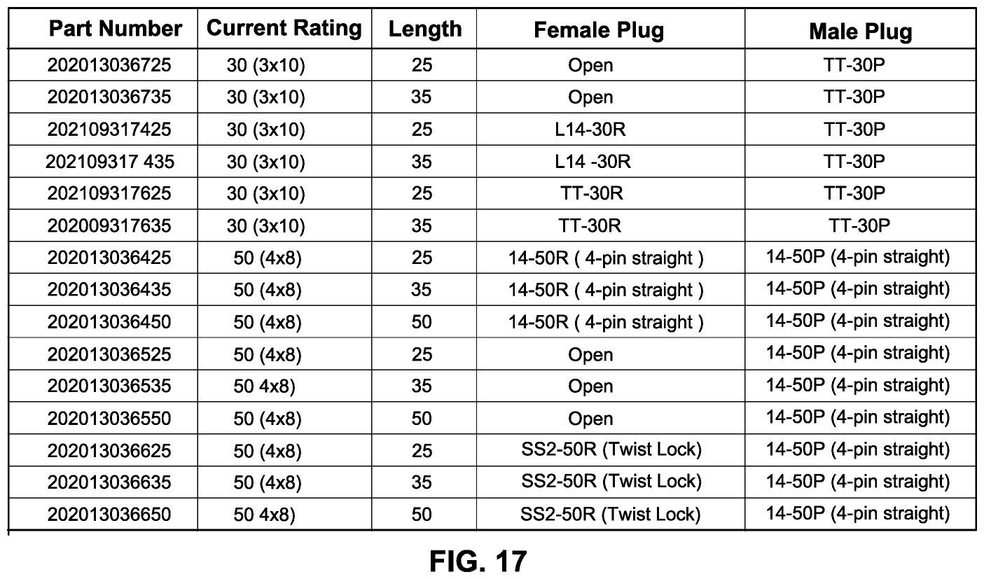

In one embodiment, the flat power cord or main power cable 19 can have a plug such as a NEMA 14-50P secured and sealed or otherwise molded to one end with silicone or the like. In other embodiments, any other suitable electrical fittings or connectors may be secured to one or both ends of the flat power cord or cable by the same method. In one embodiment also shown in FIGS. 8, 10 and 11, a free-standing flat power cord 21 may have electrical fittings secured to both first and second ends to be suitable to connect an RV power outlet to an outside power source. A non-limiting list of suitable connectors can be found in FIG. 17. With regard to the 30 amp connectors, the plugs and receptacles that have “TT-30” designation are unique to the RV and marine power cords, as they will physically not engage with residential power receptacles. The 50 amp cords typically have NEMA plugs and receptacles and can engage residential receptacles, commercial receptacles, or RV and marine power stations because of a common wiring convention.

In any of the foregoing embodiments, the neutral and ground conductors of the festoon cable 16 may be outermost conductors, and the power conductors may be inner conductors, so that the neutral and ground conductors flank the power conductors.

In an embodiment, the festoon cable 16 and the main cable 18 could be provided as a single cable, and another form of cable anchor anchoring a portion of the foregoing single cable to the main cable hub 144 could be provided in lieu of the junction block 17.

FIGS. 4A-4C show the cable assembly as it would be configured when wound onto the cable reel 14, including five wraps of the festoon cable 16 onto itself and five wraps of the main cable 18 onto itself, with no portion of the festoon cable 16 or the main cable 18 lying laterally side-by-side with any other portion of the festoon cable or main cable. Instead, successive wraps of the festoon cable 16 overlie previous wraps of the festoon cable, and successive wraps of the main cable 18 overlie previous wraps of the main cable. (In an embodiment, the assembly 10 may be sized so that five wraps of the main cable 18 onto itself as described above corresponds to an extendable and retractable length of main cable of about twenty-five feet. Other embodiments may involve more or fewer than five wraps of the festoon cable 16 and/or more or fewer than five wraps of the main cable 18.) FIG. 9 shows a cable assembly as it would be configured when the main flat cable 19 embodiment is wound onto the cable reel. In this embodiment, successive wraps of the festoon cable 16 also overlie previous wraps of the festoon cable, and successive wraps of the main flat cable 19 overlie previous wraps of the main flat cable.

The foregoing cable arrangement eliminates the need for one or more cable guides configured to route the cables laterally onto respective portions of the cable reel 14, as might be required if portions of either or both of the festoon cable 16 and the main cable 18 were arranged on the cable reel/spool 14 in a side-by-side arrangement as is common in the art. It also allows for the housing 12 to have a minimal thickness only marginally greater than the width of the festoon cable 16 and the diameter of the main cable 18 or 19.

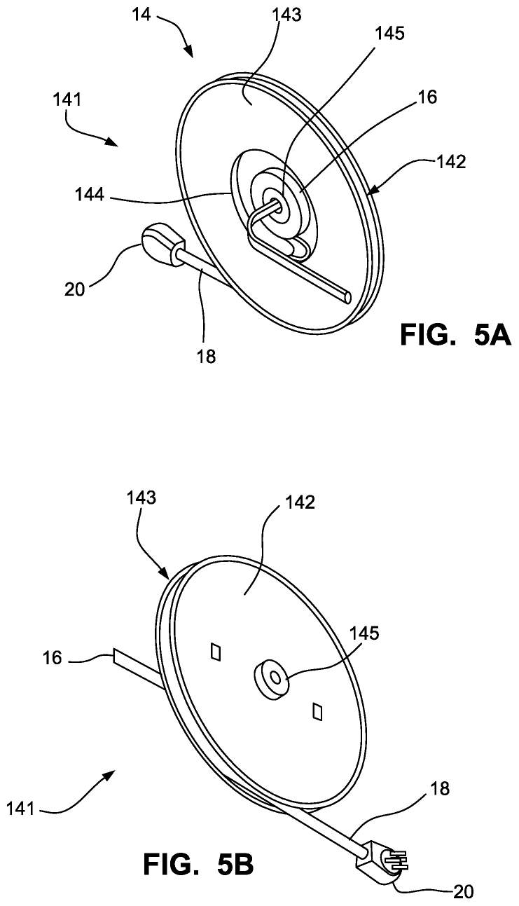

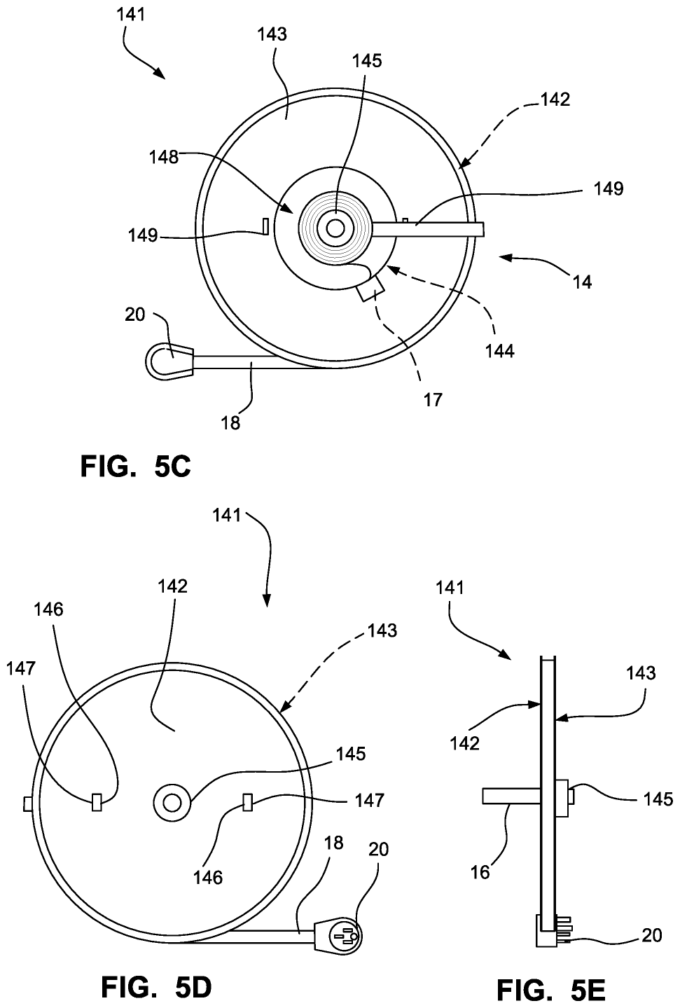

FIGS. 5A-5E show the cable assembly discussed above disposed on an illustrative spool 141 of the cable reel 14. The spool 141 includes a circular and generally planar first plate 142 and a circular and generally planar second plate 143 connected to the first plate by an intervening main cable hub 144.

The first plate 142 of the spool 141 defines a central aperture that receives a bushing 145. The bushing 145 defines a central aperture configured to be received by a spindle, as will be discussed further below. The first plate 142 of the spool also defines an indexing feature in the form of a first pair of arcuate slots 146 concentric with the central aperture and located intermediate, for example, about midway between the central aperture and the peripheral edge of the first plate. The first pair of arcuate slots 146 may be, but need not be, diametrically opposed from each other. The first pair of arcuate slots 146 is configured to receive indexing tabs extending from the main cable hub 144.

The first plate 142 of the spool further defines another indexing feature in the form of a second pair of arcuate slots 147 concentric with the central aperture and located intermediate the first and second arcuate slots 146 and the peripheral edge of the first plate. The second pair of arcuate slots 147 may be, but need not be, diametrically opposed from each other. The second pair of arcuate slots 147 may be configured to receive indexing tabs of a winding mechanism. The outer periphery of the first plate 142 is flared out of the plane of the balance of the first plate.

The second plate 143 defines a central aperture 148 configured to receive a base plate hub, as will be discussed further below. The central aperture 148 is sufficiently large to receive the fully coiled or wound festoon cable 16 therethrough. The second plate 143 also defines a further indexing feature in the form of a third pair of arcuate slots 149 located complementary to the location of the first and second slots 146 defined by the first plate 142. The third pair of arcuate slots 149 may be, but need not be, diametrically opposed from each other. The third pair of arcuate slots 149 is configured to receive indexing tabs extending from the main cable hub 144. The outer periphery of the second plate 143 is flared out of the plane of the balance of the second plate.

FIGS. 6A-6C best show the main cable hub or support 144. The main cable hub 144 is shown as a thin strip configured as a portion of a spiral, the ends of which do not overlap, thereby defining a gap 150 therebetween. The main cable hub 144 generally defines a region radially interior thereto and a region radially exterior thereto.

With a first end of the main cable hub 144 as a datum, a first pair of indexing tabs 151 extends laterally outwardly in opposite directions from both side edges of the main cable hub 144 at a location complementary to the location of one of the first pair of slots 146 defined by the first plate 142 and a corresponding one of the third pair of slots 149 defined by the second plate 143 (at about 90 degrees of rotation from the first end of the spiral, as shown), and a second pair of indexing tabs 152 extends laterally outwardly in opposite directions from both side edges of the main cable hub 144 at a location complementary to the location of the second of the first pair of slots 146 defined by the first plate 142 and the corresponding second of the third pair of slots 149 defined by the second plate 143 (at about 270 degrees of rotation from the first end of the spiral, as shown). The first and second pairs of indexing tabs 151, 152 are configured to engage, respectively, with the first pair of slots 146 in the first plate 142 and the third pair of slots 149 in the second plate 143. The first pair of indexing tabs 151 and the first ones of the pairs of slots 146, 149 may be sufficiently shorter than the second pair of indexing tabs 152 and the second ones of the pairs of slots 146, 149 so that the main cable hub 144 may be assembled to the first and second plates 142, 143 in only one orientation.

As shown in FIG. 6B, the junction block and strain relief 17 may be connected to a radially outer surface of the main cable hub 144. The gap 150 defined by the ends of the main cable hub 144 is configured to allow the festoon cable 16 to be routed therethrough.

In another embodiment, the main cable hub may be circular or another shape, and it may be closed, that is, endless. In an embodiment wherein the main cable hub 144 is closed, the main cable hub may define an aperture configured to allow the festoon cable 16 to be routed therethrough.

The first plate 142 is parallel to the second plate 143 and is spaced therefrom by a dimension marginally greater than the diameter of the main cable 18. This spacing allows the main cable 18 to be freely wound onto and unwound from the main cable hub 144 between the first and second plates 142, 143 without undue binding or abrasion. It also ensures that successive wraps of the main cable 18 overlie previous wraps of the main cable, such that no portion of the main cable is laterally beside any other portion of the main cable when the main cable is wound onto the spool 141.

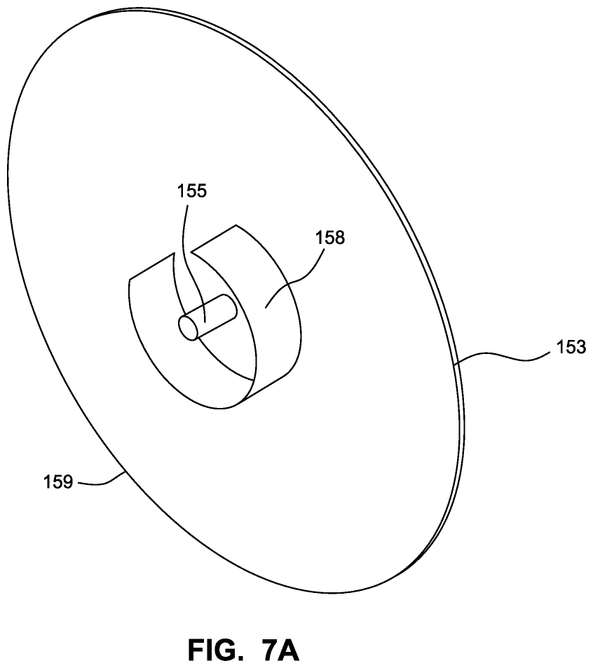

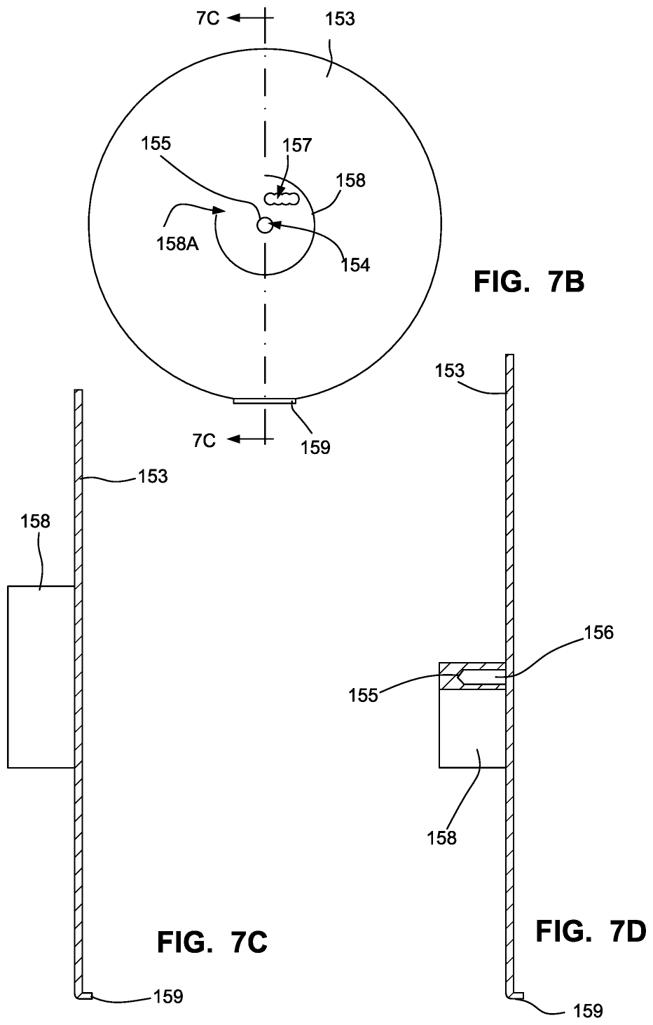

FIGS. 7A-7D show a base plate 153 of the cable reel 14. The base plate 153 is shown as, but need not be, circular. The base plate 153 defines an aperture 154 proximate its center. A spindle 155 extends perpendicularly from the base plate 153, proximate its center. The spindle 155 may define a hole 156 extending fully or partially therethrough in an axial direction. The hole 156 defined by the spindle is coaxial with the aperture 154 defined by the base plate 153. The hole 156 and the aperture 154 are configured to receive a fastener (not shown) for connecting the base plate 153 to the housing 12. The base plate 153 also defines a second aperture 157 proximate the aperture 154. The aperture 157 is configured to receive the festoon cable 16 therethrough. A grommet and/or strain relief (not shown) may be provided at the aperture 157/festoon cable 16 interface to protect the festoon cable from damage thereof.

A festoon cable hub 158 extends perpendicularly from the base plate 153. The festoon cable hub 158 is generally circular, having a center generally coaxial with the spindle 155. The festoon cable hub 158 defines a circumferential gap 158A configured to receive the festoon cable 16 therethrough. An indexing tab 159 may extend perpendicularly from the base plate 153. As shown, the indexing tab 159 may be monolithically formed with the base plate 153 and bent to a configuration perpendicular thereto. The indexing tab 159 is configured to engage with a corresponding aperture defined by the housing 12 to preclude rotation of the base plate 153 with respect to the housing.

In another embodiment, the rear panel 122 of the housing 12 could include features analogous to the base plate 153. In such an embodiment, the base plate 153 could be omitted as a distinct structure.

The cable reel assembly 10 may be assembled by connecting the terminal block 17 to the main cable hub 144. The festoon cable 16 and the main cable 18 may be connected to respective terminals of the terminal block 17, with the festoon cable 16 routed to the interior region defined by the main cable hub 144 and the main cable routed to the exterior region defined by the main cable hub.

The main cable hub 144 may be sandwiched between the first and second plates 142, 143, with the first and second pairs of indexing tabs 151, 152 of the main cable hub 144 engaged with corresponding ones of the first pair of indexing slots 146 in the first plate 142 and the third pair of indexing slots 149 in the second plate 143. In the embodiment shown, the indexing tabs 151, 152 are no longer than necessary to enable indexing of the main cable hub 144 to the side plates 142, 143. In this embodiment, the main cable hub 144 may be connected to the side plates 142, 143, for example, by welding. In another embodiment (not shown), the indexing tabs 151, 152 may be sufficiently long to extend through the respective slots a sufficient distance enabling the tabs to be folded over against the respective plates 142, 143 to thereby secure the plates to the main cable hub 144. In yet another embodiment, the indexing tabs 151, 152 and corresponding slots in the side plate 142, 143 could be omitted. In such an embodiment, the main cable hub 144 could be located with respect to the first and second side plates 142, 143 in another suitable manner and connected thereto, for example, by welding.

The first and second plates 142, 143 may be oriented so that their peripheries flare outwardly with respect to each other. This feature may help to inhibit abrasion of the main cable 18 as it is wound onto and unwound off of the cable reel 14.

The main cable 18 may be coiled about the outer surface of the main cable hub 144 between the first and second plates 142, 143, with each wrap of the main cable overlying the previous wrap thereof so that the main cable is wound onto the main cable support with no wraps thereof in a substantial side-by-side relationship with other wraps thereof.

The festoon cable 16 may be coiled within the interior of the main cable hub 144 through the opening 148 in the second plate 143, with each wrap of the festoon cable 16 overlying the previous wrap thereof or otherwise so that the festoon cable is wound onto the first cable support with no wraps thereof in a substantial side-by-side relationship with other wraps thereof.

The foregoing cable and cable reel subassembly may be assembled to the base plate 153 by inserting the free end of the festoon cable 16 through the aperture 157 defined by the base plate 153 and by placing the coiled festoon cable 16 over the festoon cable hub 158 so that the festoon cable hub is received within the coiled festoon cable, and so that the spindle 155 of the base plate 153 is received by the bushing 145 of the first plate 142.

The foregoing base plate 153, cables 16, 18, and cable reel 14 subassembly may be connected to the second plate 122 of the housing 12 by routing the free end of the festoon cable through the aperture 34 defined by the second plate 122. The first plate 121 of the housing may be connected to the second plate 122 of the housing, thereby enclosing the cable reel 14 therein.

The free end of the main cable 18 may be routed through the aperture 22 defined by the housing 12. The electrical fitting 20 may be connected to the free end of the main cable 18.

As suggested above, the cable reel assembly 10 may include a winding mechanism 100 configured to rotate the cable reel 14 with respect to the housing 12 to thereby retract the main cable 18 into the housing 12. The winding mechanism also could be configured to rotate the cable reel 14 with respect to the housing 12 to thereby extend the main cable 18 from the housing 12. Such a winding mechanism could be generally contained within a cover 102 connected to housing 12.

In an embodiment, the winding mechanism 100 could be a spiral wound spring (not shown) connected between the housing 12 and the cable reel 14 so that the spring becomes tensioned when the cable reel is rotated in response to the main cable 18 being withdrawn from the housing. A ratchet mechanism including a ratchet dog and latch (not shown) could be provided to selectively preclude the tensioned spring from rotating the cable reel so as to retract the main cable 18 into the housing 12. The latch could be selectively operated to release the ratchet mechanism, thereby enabling the spring to rotate the cable reel so as to retract the main cable 18 into the housing 12.

In use, the main cable 18 may be extended from the housing, for example, by a user pulling on the free end of the main cable or the fitting 20, thereby causing the cable reel 14 to rotate in a first direction, and the main cord to unwind from the main cable hub. Such rotation of the cable reel 14 also causes the festoon cable to become less tightly wrapped about the festoon cable hub 158, while remaining in a coiled condition with each wrap of the festoon cable continuing to overlie either the festoon cable or a previous wrap of the festoon cable.

The winding mechanism may be used to the rotate the cable reel 14 in a second direction opposite the first direction, thereby drawing the main cable 18 into the housing and onto the main cable hub 144. Such rotation of the cable reel 14 also causes the festoon cable to become more tightly wrapped about the festoon cable hub 158.

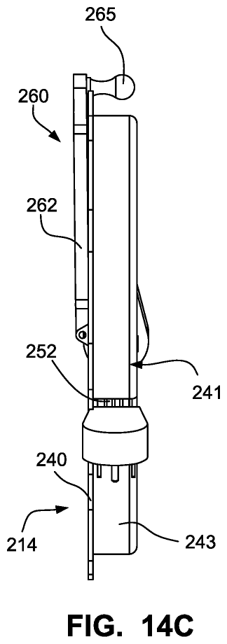

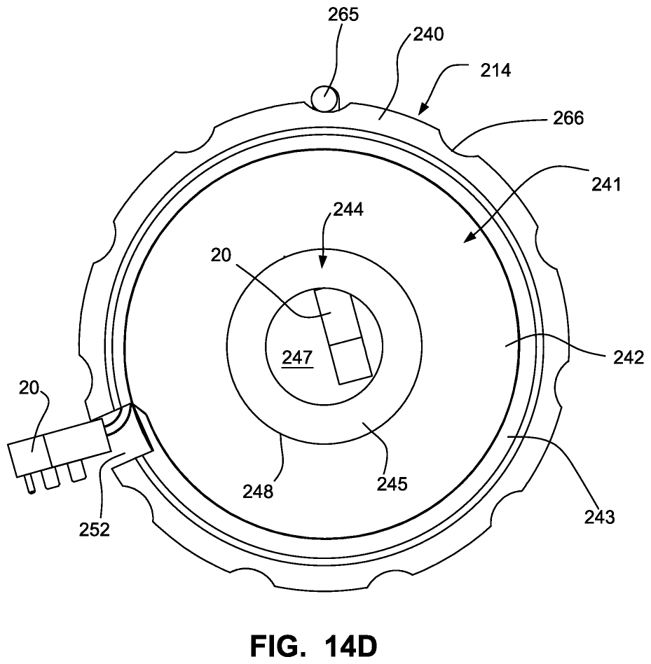

In another embodiment, the winding mechanism could be a mechanical crank and spool as shown in FIGS. 14A-14D, 15, and 16. This reel embodiment will be indicated in the figures as 214. As shown, the housing is eliminated in this embodiment, and a removable power cord 218 is maintained in a cord spool 241 with an aperture 248 in the center for receiving a main cord hub 244 on which the power cord 218 may be wound and unwound. The cord spool 241 includes a planar surface 242 of a generally circular shape with a circular side wall 243 extending perpendicularly from the periphery of the planar surface 242. The side wall 243 has a width approximate to or slightly larger than the width of the power cord 218. The cord spool side wall 243 includes an opening 252 for entry and exit of the power cord 218 during use. The opening 252 may be beveled, include a lip, or may include other features for reducing friction between the power cord and the cord spool opening 252 as the cord is wound or unwound. The dimensions of the planar surface 242 and the side wall 243 are sized to encompass the power cord 218 so that each wrap of the cord overlies the previous wrap thereof so that the cord is wound onto the main cord hub 244 with no wraps thereof in a substantial side-by-side relationship with other wraps thereof. The cord spool side wall 243 may flare outwardly from the outer periphery of the planar surface 242 for reducing friction and preventing binding as the power cord 218 is wound and unwound from the cord reel 214. The cord spool 241 may also include a crank engagement flange 240 that extends perpendicularly outward from the side wall 243. Preferably, the spool planar surface 242 and the crank engagement flange 240 respectively extend from opposite sides of the circular side wall 243. The crank engagement flange 240 will be described in greater detail below.

As previously described, the main cord hub 244 is received in the spool aperture 248. The aperture 248 is located in the center of the planar surface 242. The main cord hub 244 contains a planar ring 245 that abuts the cord spool planar surface 242. The main cord hub 244 also includes a circular side wall 246 that extends perpendicularly from the inner periphery of the planar ring 245. The planar ring 245 and the circular side wall 246 together create an aperture 247 of the main cord hub 244. The side wall 246 of the main cord hub 244 may be continuous and includes an opening 249 for receiving an end of the power cord 218, which will be described in greater detail below. In other embodiments, the main cord hub 244 may be discontinuous to provide the opening 249.

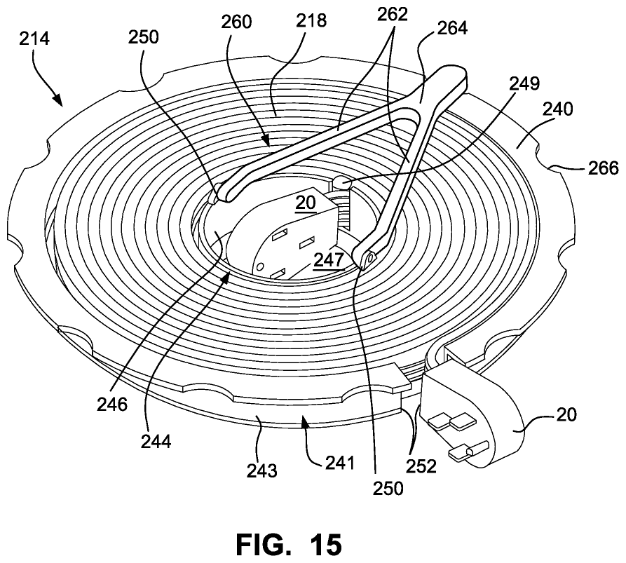

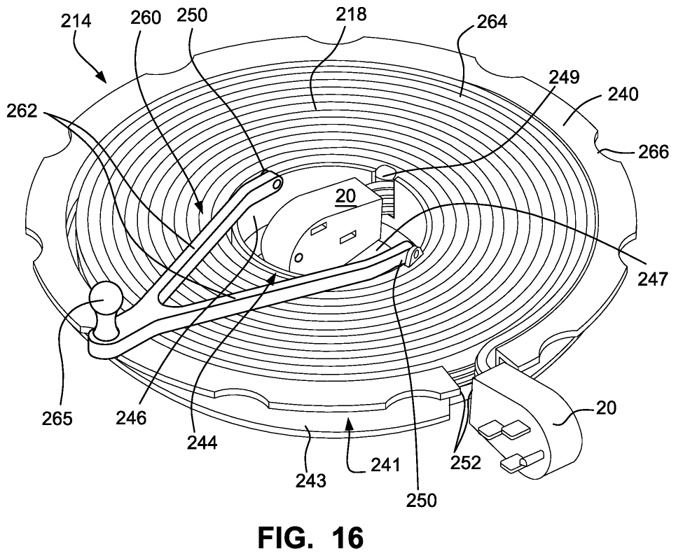

The main cord hub 244 contains at least one tab 250 extending from the outer periphery of the side wall 246 for pivotably mounting a leg 262 from a crank 260. Preferably, the main cord hub 244 contains two tabs 250 positioned on opposite sides of the circumference of the side wall 246 of the main cord hub 244 for pivotably mounting two legs 262 from a two-pronged or wishbone-shaped crank. The crank legs and main cord hub tabs may be pivotably connected by one of the legs 262 or tabs 250 containing a peg that is received in an aperture of the other of the legs or tabs. The crank 260 is pivotably mounted to the main cord hub 244 to move between a lock position shown in FIG. 15 for prohibiting rotation of the cord reel 214 to a release position shown in FIG. 16 for allowing rotation of the cord reel 214 in one of two directions. The crank 260 includes a handle portion 264 distal from the crank leg or legs 262, and the handle 264 may contain a locking knob 265 on its outer end.

The crank engagement flange 240 may contain valleys or cutouts 266 along its outer periphery for engaging and retaining the locking knob 265 of the crank 260 when the crank is moved into the lock position for prohibiting rotation of the cable reel 214. When the locking knob 265 of the crank 260 is retained by the engagement flange 240, the power cord 218 is also substantially prevented from rotation or movement. The crank 260 may be pivoted into the release position to release the locking knob 265 and allow for rotation of the cord reel 214. In the embodiment shown, the crank 260 is pivoted 180° between the lock position to the release position where it abuts a radially opposed side of the crank engagement flange 240 with the locking knob 265 facing upwardly or away from the cord reel 214. In other embodiments, the crank may pivot less than 180° or may use a different locking mechanism. A spring or detent mechanism (not shown) may be included between the main cord hub tabs 250 and the crank legs 262 for maintaining the crank 260 in the lock position or the release position. The crank 260 also serves to retain the power cord 218 inside of the cord spool 241 by creating a barrier opposite the planar surface 242 of the cord spool.

The mechanical crank and spool cord reel 214 may be mounted or may be portable. Similar to previously described embodiments, cord reel 214 contains the power cord 218 in a single layer, which allows for a space-saving and discreet assembly that can be easily mounted or stored in many locations. If mounted, the cord spool 241 may include apertures, fasteners, and other mounting features to attach the cord reel assembly 214 to a surface. If portable, the weight of the assembly may maintain the cord spool 241 in a stationary position. In an embodiment that is portable, cord reel assembly 214 will act as an organizational storage device for a free-standing power cord.

In use, the crank handle 264 is pulled away from the crank engagement flange 240 to release the locking knob 265 from one of the valleys or cutouts 266 of the crank engagement flange 240 to pivot the crank 260 into the release position. In the release position, the crank 260 can be grasped by one or both of the handle 264 and locking knob 265 to rotate the crank in a circular motion about the cord spool 241 in one of two directions to either wind or unwind the power cord 218 from the assembly. With the crank 260 in the release position, the side of the crank 260 opposite from the locking knob lays against the crank engagement flange 240, which serves to facilitate operation of the crank 260. Additionally, the crank legs 262 maintain alignment of the power cable 218 during winding/unwinding. The power cord 218 may also be pulled to be unwound from the cord reel assembly 214 when the crank 260 is in the release position.

As shown in FIGS. 14A-14D, 15, and 16, the power cord 218 may have electrical fittings 20 on the first and second ends of the cord. As shown, the second end of the power cord 218 is releasably held by the main cord hub opening 249. The second end of the power cord 218 is anchored to the main cord hub 244 as the main cord hub is rotated by the crank 260 for winding and unwinding of the power cord 218. In other embodiments, the reel assembly 214 may be adapted to receive a festoon cable 16 inside of the main hub 244 for connection to an electrical panel or power source at one end and to a main cable 18 at its second end.

In other embodiments, the winding mechanism of one of the foregoing reel embodiments could include an electric motor configured to rotate the cable reel.

Dimensions, weld details, and the like, shown in the drawings are illustrative and not limiting. References herein to orientation, for example, top, bottom, front, rear, left, right, and the like, refer to relative and not necessarily absolute orientation. Accordingly, such references are illustrative and not limiting.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A multi-conductor flat cable having a width and a thickness and comprising a plurality of individual conductors arranged side-by-side, including first and second power conductors, a neutral conductor, and a ground conductor.

2. A multi-conductor flat cable according to claim 1, wherein the first and second power conductors comprise 8 AWG power conductors.

3. A multi-conductor flat cable according to claim 2, wherein the neutral conductor comprises a 6 AWG neutral conductor.

4. A multi-conductor flat cable according to claim 3, wherein the ground conductor comprises a 6 AWG ground conductor.

5. A multi-conductor flat cable according to claim 1, wherein the plurality of individual conductors are rated to carry a 50 ampere current.

6. A multi-conductor flat cable according to claim 1, wherein the neutral conductor and the ground conductor are outermost conductors, and wherein the first and second power conductors are inner conductors.

7. A multi-conductor flat cable in combination with a main cable,
the multi-conductor flat cable having a width and a thickness and comprising a plurality of individual conductors arranged side-by-side, including first and second power conductors, a neutral conductor, and a ground conductor; and
the main cable comprising a flat flexible cable including 8-gauge wires set in a linear or side-by-side formation,
wherein the main cable is electrically coupled to the multi-conductor flat cable at a first end and is secured to an electrical fitting at a second end.

8. A combination according to claim 7, wherein the main cable comprises a 50 AMP cable.

9. A combination according to claim 7, wherein at least one of the multi-conductor flat cable and the main cable comprises a NEMA 14-50P plug secured and sealed or otherwise molded to one end.

10. A combination according to claim 7, wherein the neutral conductor and the ground conductor are outermost conductors, and wherein the first and second power conductors are inner conductors.

11. A free-standing flat power cord having a width and a thickness, the flat power cord comprising a 30 or 50 amp cord including a plurality of conductors, wherein the conductors comprise multiple strands.

12. A free-standing flat power cord according to claim 11, wherein the cord is the 30 amp cord and comprises 10 AWG wires.

13. A free-standing flat power cord according to claim 11, wherein the cord is the 50 amp cord and comprises 8 AWG wires.

14. A free-standing flat power cord according to claim 11, wherein the conductors comprise 125 strands.

15. A free-standing flat power cord according to claim 11, further comprising individually insulated wires disposed in a flat cord jacket.

16. A free-standing flat power cord according to claim 15, comprising four conductors including first and second power conductors, a neutral conductor, and a ground conductor.

17. A free-standing flat power cord according to claim 16, wherein the cord is the 50 amp cord, and wherein a potential difference between the first and second power conductors is 240v, and a potential difference between the first and second power conductors and the neutral conductor is 120v.

18. A free-standing flat power cord according to claim 17, wherein a potential difference between either of the first and second power conductors and the ground conductor is 120v.

19. A free-standing flat power cord according to claim 16, wherein the neutral conductor and the ground conductor are outermost conductors, and wherein the first and second power conductors are inner conductors.

20. A free-standing flat power cord according to claim 11, wherein the power cord is rated for 600v and provides an output of 4 kW-h or higher.

21. A free-standing flat power cord according to claim 11, further comprising electrical fittings secured to first and second ends configured to connect an RV power outlet to an outside power source.

22. A free-standing flat power cord according to claim 11, wherein the cord is a 50 amp cord, the cord further comprising NEMA plugs and receptacles configured to engage residential receptacles, commercial receptacles, or RV and marine power stations.
